(19) United States
(12) Patent Application Publication
(10) Pub. No.: US 2005/0163554 A1
(43) Pub. Date: Jul. 28, 2005

(54) Lipstick activation mechanism

(76) Inventor: Ernesto Cara Sanchez, Barcelona (ES)

Correspondence Address: YOUNG & THOMPSON, 745 SOUTH 23RD STREET, 2ND FLOOR, ARLINGTON, VA, 22202, US

(21) Appl. No.: 11/022,634

(22) Filed: Dec. 28, 2004

(30) Foreign Application Priority Data
Dec. 30, 2003 (ES) P200303071

(51) Int. Cl. B43K 21/08; A45D 40/06

(52) U.S. Cl. 401/69; 401/75

(57) ABSTRACT

A cylinder base part that can rotate on a funnel casing is equipped with a base for its activation, and an internally threaded neck inside of which an externally and internally threaded middle part can be moved telescopically. Inside the middle part, an externally threaded part of a slide part making up the container for the lipstick bar acts telescopically so that rotation of the base part with respect to the funnel casing initially produces an axial and unified movement of the middle part and the slide part, without any rotation of either of these parts. When the middle part reaches its maximum forward position, it moves on to accompany the base part in its rotation movement, continuing the axial movement and in the absence of rotation of the slide part, which allows the container and the lipstick bar, to adopt a geometric configuration.

### PURPOSE OF THE INVENTION

This invention refers to a lipstick activation mechanism, whose clear purpose is to perform the internal movement of the casing corresponding to the container part of the lipstick bar; this movement is performed in an axial and linear manner, which allows both the above-mentioned lipstick bar container and the lipstick bar to have any adequate configuration, oval, triangular, etc.

### BACKGROUND OF THE INVENTION

As is known, a lipstick includes a support casing on which a part is placed and whose rotation produces the emergence or retraction of the lipstick bar itself; said movement is performed by rotating both the lipstick bar support and the lipstick bar, for which the lipstick bars must have a cylinder configuration and the mechanism must have notable dimensions as regards to length, specifically, the part acting as a slide must have the same length than that of the corresponding height of the lipstick bar.

That is, conventional lipsticks have limitations in terms of both configuration and dimensions.

### DESCRIPTION OF THE INVENTION

The mechanism that is recommended has been designed to solve the above-mentioned problem based on a simple and effective solution, since it is designed in such a way that the movement of the lipstick bar support is performed telescopically and linearly and not by rotation, which makes it impossible for said support and therefore the actual lipstick bar to have any configuration appropriate for any line of design, thus gaining aesthetically and in variety.

More specifically, the mechanism of the invention is composed of four basic parts, one as an activation part, another as a double-threaded middle part, another as a slide part, and the last one as a container part that supports the entire mechanism.

The activation part is cylinder shaped and has two very distinct parts; one is heretofore named base, with the appropriate configuration that allows its adaptation to any aesthetic external part, which also serves as a support for the user's fingers and allows performing the rotation and corresponding activation of such a part and, finally, of the mechanism set: the other part of said activation part is composed of an internally threaded cylinder neck that also has, along its internal ends, blocking supports of the housing part and protection of the mechanism set, leaving both parts interlocked in an axial manner.

The internal thread of the cylinder neck that corresponds to said activation part corresponds to a thread that belongs to the middle part, which is a cylinder-shaped part with external threads that engages to the threads of the neck of the activation part, and with an internal thread that specifically engages the slide part, which extends the latter along its internal end in the corresponding support or container of the lipstick part, heretofore called thread section of said cylinder slide part, with external threads along its entire length.

The entire mechanism, including the support part interlocked to the activation part, will be complemented with the corresponding cover that, as with the bar itself and the bar's support part, can have any configuration.

This mechanism offers a series of advantages with respect to the conventional ones used for the same purpose, among which the following can be indicated:
Linear movement of the slide part and therefore the lipstick bar, which allows creating any type of bar, either oval, triangular, heart-shaped bars, etc.
The telescopic system reduces, with respect to the conventional ones with thread-dowel systems, the height of the mechanism, which also allows mounting on aesthetic bases that are much shorter than the existing ones, since the height of the cylinder slide part of the slide part thread does not have to be the same as the height of the lipstick bar.
Possibility of having aesthetic casing with any shape and finish.
Reduction of the total height dimensions of the entire set of the lipstick with respect to conventional ones.

### DESCRIPTION OF THE DRAWINGS

To complement the description being made and with the purpose of helping to obtain a greater understanding of the characteristics of the invention, according to a preferred practical embodiment example of the same, as an integral part of said description, a set of drawings is provided in which the following is represented for illustration non-limiting purposes:

FIG. 1.−Shows a side longitudinal view of a lipstick with the activation mechanism that is the purpose of the invention; the latter is in a standby position; that is, it is retracted from the lipstick bar support.

FIG. 2.—Shows a longitudinal section as in the previous figure, with the activation part activated, and with the dual thread middle part moved.

FIG. 3.—Shows a view that is similar to the previous figures, but with another movement phase in which the axial and full movement of the sliding part and, therefore, of the lipstick bar support, has been produced.

FIG. 4.—Shows, according to a representation that is similar to the previous figures, different practical embodiment examples of a lipstick with the mechanism of the invention.

### PREFERABLE EMBODIMENT OF THE INVENTION

In reference to the mentioned figures, one can observe how the activation mechanism of a lipstick that is the purpose of the invention is composed of four basic parts, referenced with numbers (1), (2), (3), and (4).

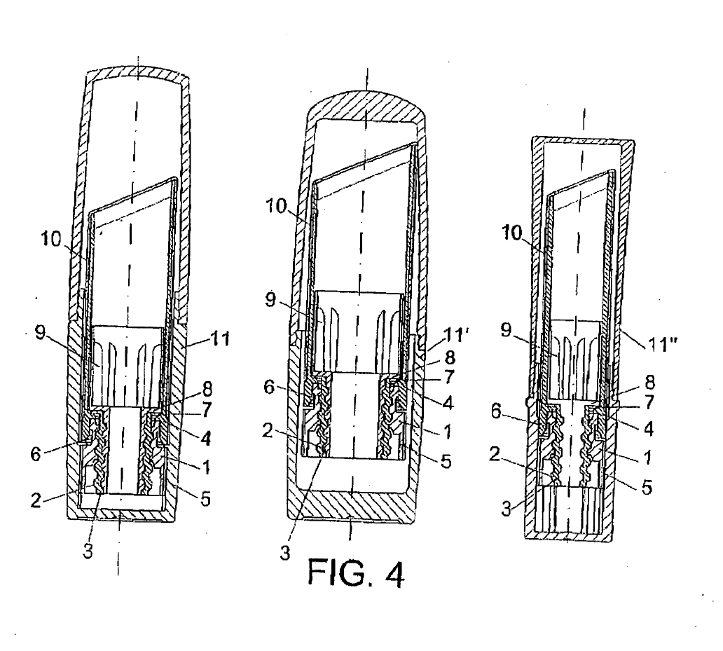

The base part (1), through which the manual activation of the device is performed, from the external casing, is equipped with two parts, a base (5) that can be adapted to any aesthetic external part, as indicated in FIG. 4, for receiving the rotating movement of the latter and a cylinder neck (6), with internal threads (6′), so that, through the end of said neck (6) of the base part (1), the funnel casing (4) is interlocked and fixed, and which composes the location resource for the entire mechanism and, in turn, the guiding resources for the lipstick bar container, as will be shown later, which will preferably be assisted by a cover (10).

The middle part (2) has a cylinder configuration with a dual thread; that is, it is equipped with an external and internal thread train and has, along its internal end, a perimeter stopper tab (7) for base (8) and slide part (3) corresponding to the container (9) of the lipstick bar, which is not represented; this container (9) belongs to the slide part (3) that is equipped with a cylinder slide part with external threads for engaging with the internal threads of part (2).

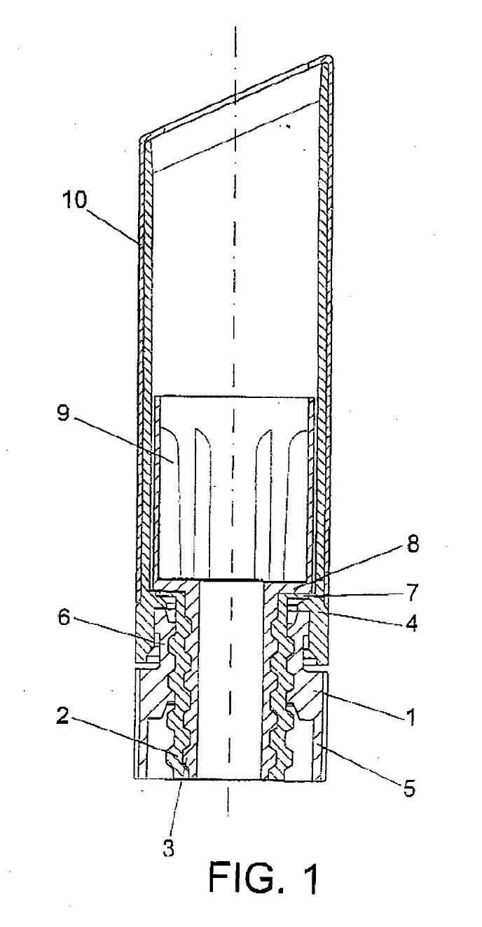

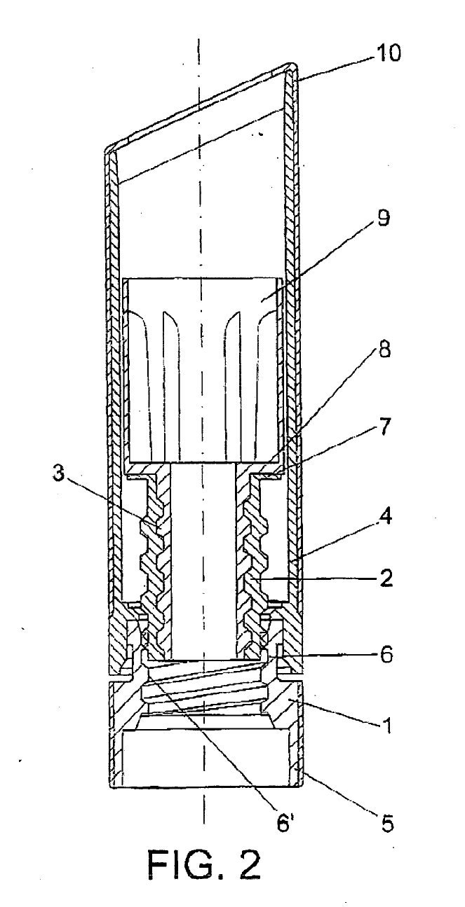

According to this structuring and from the standby or retraction position of the lipstick bar represented in FIG. 1, when the manual rotating movement is provided to base (5) of part (1), it acts as a female screw that trigger the axial movement, through its threaded neck (6), of middle part (2) that, in turn, acts as a spindle, without the latter suffering any rotating movement, and dragging, during said axial movement, slide part (8), which is the part that holds the lipstick bar as indicated in FIG. 2.

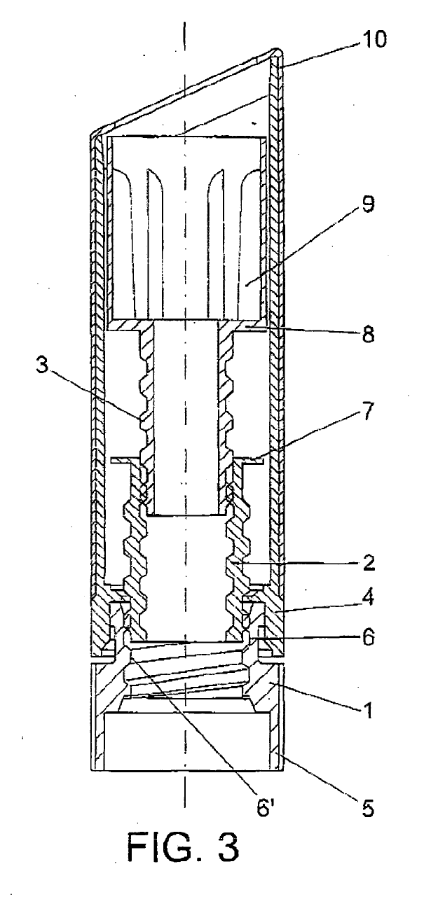

When middle part (2) is immobilised to continue moving in an axial manner, because it acts as a stopper on the internal end of the neck (6) of part (1), said middle part also acts as a female screw immobilised to base part (1), which, during its rotating movement, axially moves slide part (3), specifically to its lower cylinder slide part so that the lipstick bar housed in container (9) keeps moving axially but remains static in the angular direction, as indicated in FIG. 3, which, as indicated repeatedly, allows said lipstick bar to adopt any configuration other than a cylinder shape.

It only remains to be shown that, as indicated in FIG. 4, the mechanism represented in FIGS. 1 to 3 can be inserted onto casings (11), (11′), (11″) with the greatest number of configuration variations.

1. Lipstick activation mechanism that, being applicable to lipsticks equipped with a casing that contains said mechanism, with a housing for the lipstick bar, which together with the latter can emerge to the outside by a manual and rotating movement applied to the base of the device, through the casing of the same, is characterised in that it incorporates a cylinder base part (1), equipped with a lower base (5) and a top internally threaded neck (6), a base part (1) inside of which an internally and externally threaded middle part (2) acts and inside of which there is, in turn, a slide part (3) belonging to an internal part that configures a cylinder slide part and container (9) for the lipstick bar, which can move in an axial manner inside the funnel casing part (4), assisted by a cover (10), which constitutes the fixed element with respect to the rotation of the base part (1).

2. Lipstick activation mechanism according to claim 1, characterised in that the base part (1), during its rotation movement, axially moves the middle part (2) that acts as a spindle and remains static in the angular direction until the limit of the axial movement, at which time, it accompanies the base part (1) in its rotating movement and, in turn, acts as a female screw for the axial movement in its interior of the slide part (3), which continues its axial movement whilst immobilised in the angular direction, which allows the housing (9) of the lipstick bar, as with the latter, to have any configuration, both cylinder shaped and any other shape.
